(19) United States
(12) Patent Application Publication
(10) Pub. No.: US 2011/0264769 A1
(43) Pub. Date: Oct. 27, 2011

(54) CONTENT SPECIFYING APPARATUS AND PROGRAM OF THE SAME

(76) Inventor: Munehiro YONEDA, Neyagawa-shi (JP)

(21) Appl. No.: 13/025,425

(22) Filed: Feb. 11, 2011

(30) Foreign Application Priority Data
Apr. 27, 2010 (JP) 2010-102694

(51) Int. Cl. G06F 15/16

(52) U.S. Cl. 709/219

(57) ABSTRACT

A tune is subjected to preset registration without managing an URL of the tune, and the tune subjected to the preset registration is surely specified from a tune list in response to a preset reproduction instruction. When an instruction to perform the preset registration is inputted, a title of the selected tune and a title(s) of one or a plurality of folders selected until the selected tune is reached are managed in a tune specification table. When an instruction to perform the preset reproduction is inputted, the title(s) of the one or the plurality of folders, and the title of the tune managed in the tune specification table are automatically selected from the tune list, by which the preset tune is automatically specified from the tune list.

### BACKGROUND OF THE INVENTION

1. Field of the Invention

The present invention relates to a content specifying apparatus that specifies a content from a content list.

2. Description of the Related Art

An AV amplifier has a function as an internet radio terminal, which can acquire content data (tune data) in a streaming form via internet from an internet radio server to reproduce the data. The AV amplifier acquires a tune list from the server to display on a display apparatus, and a user selects a desired tune to be reproduced from the tune list. When in a state where a tune is selected from the tune list, or in a state where the selected tune is being reproduced, an instruction to perform preset registration of the selected tune is inputted by user operation, an URL of the selected tune is registered. When an instruction to perform preset reproduction is inputted by user operation, the AV amplifier reads the URL registered in association with the preset, and connects to the URL, by which the tune subjected to the preset registration can be acquired from the server and be reproduced.

Here, many of URLs of tunes of the internet radio are temporary, and may be changed by an operator of the server. If the URL is changed, the AV amplifier cannot be connected to the URL registered in association with the preset, and cannot acquire the tune subjected to the preset registration from the server.

Moreover, a resume reproduction function can be considered, in which when the AV amplifier shifts from a power-on state to a standby state in response to user operation, a URL of a tune being reproduced is stored in a memory, and next time the AV amplifier shifts to the power-on state, the URL stored in the memory is connected to thereby reproduce the tune being reproduced at the time of the shift to the standby state. In this case as well, when the URL of the tune is changed, the AV amplifier cannot be connected to the URL stored in the memory, so that the tune being reproduced at the time of the shift to the standby state cannot be acquired from the server.

### SUMMARY OF THE INVENTION

An object of the present invention is to provide a content specifying apparatus in which information of selected content has been managed, and later, the managed content can be surely specified from a content list.

A content specifying apparatus according to the preferred embodiment of the present invention comprises: a list acquiring unit that acquires a content list including identification information of one or a plurality of folders, and/or identification information of one or a plurality of contents; a selection unit that selects a content from the content list in response to user operation; a management unit that manages the identification information of the selected content and the identification information of one or a plurality of folders selected until the selected content is reached; and a specification unit that specifies the content from the content list, using the identification information of the one or the plurality of folders and the identification information of the content managed by the management unit.

The management unit has managed the identification information of the content selected by selection unit, and the identification information of the one or the plurality of folders selected until the selected content is reached. Later, the specification unit specifies the content from the content list, using the identification information of the one or the plurality of folders, and the identification information of the content managed by the management unit. Accordingly, later, the content selected by the user operation can be surely specified from the content list without managing the URL of the content.

Preferably the specification unit selects, from the content list, the folder specified by the identification information of the folder managed by the management unit, and selects, from the content list, the content specified by the identification information of the content managed by the management unit.

Preferably the content specifying apparatus further comprises a reproduction unit that reproduces the content specified by the specification unit. When an instruction to subject the selected content to preset registration is inputted by user operation, the management unit manages the identification information of the selected content, and the identification information of the one or the plurality of folders selected until the selected content is reached, and when an instruction to perform preset reproduction is inputted by user operation, the specification unit specifies the content from the content list, and the reproduction unit reproduces the content specified by the specification unit.

When the instruction to perform the preset registration is inputted, the management unit manages the identification information of the selected content and the identification information of the one or the plurality of folders selected until the selected content is reached. When the instruction to perform the preset reproduction is inputted, the specification unit specifies the content from the content list, using the identification information of the one or the plurality of folders and the identification information of the content managed by the management unit. Accordingly, the content is subjected to the preset registration, and later, the content subjected to the preset registration can be surely specified from the content list without managing the URL of the content.

Preferably the content specifying apparatus further comprises a reproduction unit that reproduces the content selected by the selection unit or the content specified by the specification unit. When the content specifying apparatus shifts from a power-on state to a standby state, the management unit manages the identification information of the content being reproduced by the reproduction unit and the identification information of the one or the plurality of folders selected until the content being reproduced by the reproduction unit is reached, and when the content specifying apparatus shifts from the standby state to the power-on state, the specification unit specifies the content from the content list, and the reproduction unit reproduces the content specified by the specification unit.

When the content specifying apparatus shifts from the power-on state to the standby state, the management unit manages the identification information of the tune being reproduced, and the identification information of the one or the plurality of folders selected until the selected content is reached. Next time the content specifying apparatus shifts from the standby state to the power-on state, the specification unit specifies the content from the content list, using the identification information of the one or the plurality of folders and the identification information of the content managed by the management unit. Accordingly, later, the stored content can be surely specified from the content list without managing the URL of the content to perform the resume reproduction.

### BRIEF DESCRIPTION OF THE DRAWINGS

FIG. 1 is a block diagram showing an AV amplifier according to a preferred embodiment of the present invention.

FIG. 2 is a diagram showing a tune list.

FIG. 3 is a diagram showing a tune list.

FIG. 4 is a diagram showing a tune specification table.

FIG. 5 is a flowchart showing processing of a control unit 2.

FIG. 6 is a flowchart showing processing of the control unit 2.

FIG. 7 is a flowchart showing processing of the control unit 2.

FIG. 8 is a flowchart showing processing of the control unit 2.

FIG. 9 is a flowchart showing processing of the control unit 2.

FIG. 10 is a flowchart showing processing of the control unit 2.

FIG. 11 is a flowchart showing processing of the control unit 2.

FIG. 12 is a flowchart showing processing of the control unit 2.

### DETAILED DESCRIPTION OF THE PREFERRED EMBODIMENTS

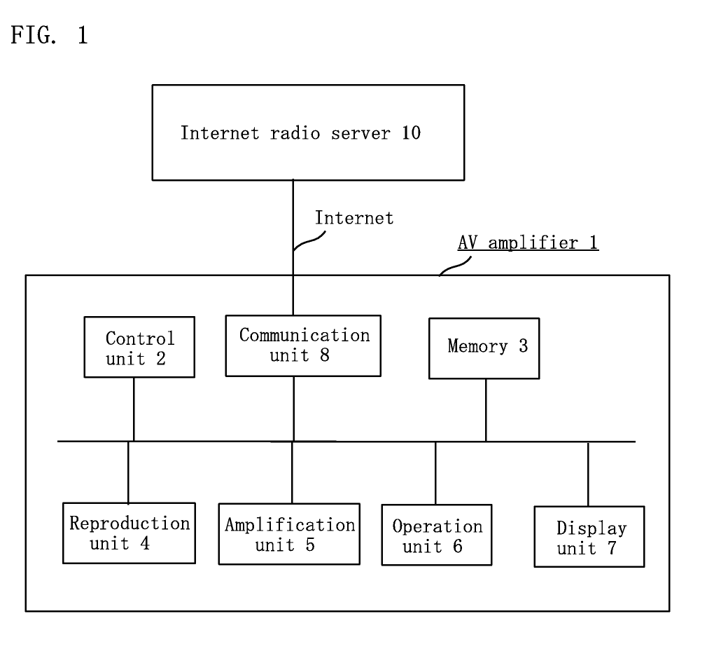

Hereinafter, while preferred embodiments of the present invention are specifically described with reference to the drawings, the present invention is not limited to these embodiments. As shown in FIG. 1, an AV amplifier 1 functioning as a content specifying apparatus according to the present embodiment can be connected to one or a plurality of internet radio servers (hereinafter, referred to as server(s)) 10 via an arbitrary electric communication line such as the internet. The AV amplifier 1 acquires content data from the server 10, for example, in a streaming form and reproduces the same. The content data, which is a generic term for tune (music, voice) data, video data, image data and the like, is tune data (a tune file) in the present example. The AV amplifier 1 receives, from the server 10, a content list (hereinafter, referred to as a tune list), which is a list of tunes and folders (containers) accumulated by the server 10, and causes the same to be displayed on a display unit 7. When a tune is selected from the tune list by user operation, the AV amplifier 1 requests and acquires the tune data from the server 10 to reproduce the same.

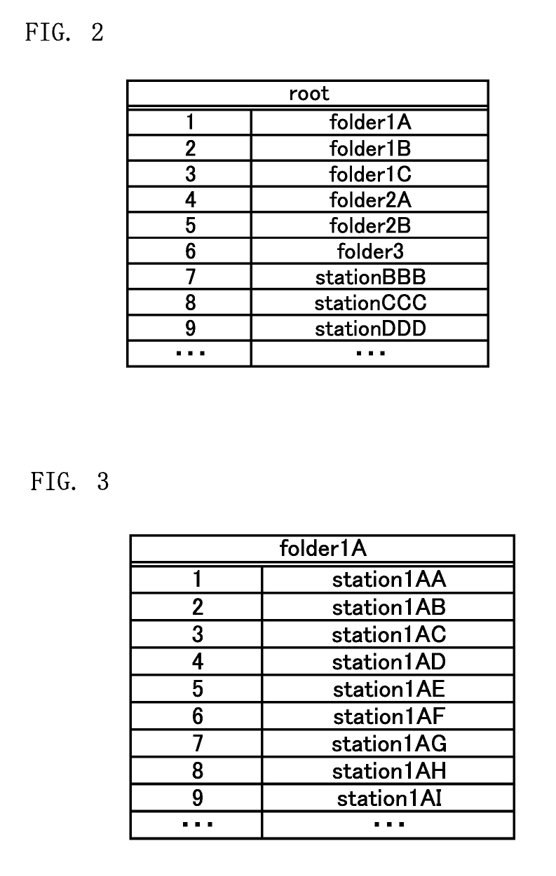

The tune list displayed by the AV amplifier 1 is described. The tune list has a hierarchical structure. First, as shown in FIG. 2, a list of folders (and tunes) included in a root, which is in the highest order, is displayed. In FIG. 2, “folder1A” to “folder3” indicate folders, and “stationBBB” to “stationDDD” indicate tunes (reproducible items). For example, when “stationBBB” is selected by the user operation, the AV amplifier 1 acquires the tune data of “stationBBB” from the server 10 to reproduce the same. When “folder1A” is selected by the user operation, a list of folders and/or tunes included in “folder1A” is acquired from the server 10, and displayed, as shown in FIG. 3. That is, when the folder is selected, the list at a one lower hierarchy is displayed. In FIG. 3, “station1AA” to “station1AI” indicate tunes. For example, when “station1AA” is selected by the user operation, the AV amplifier 1 acquires “station1AA” from the server 10 to reproduce the same.

As shown in FIG. 1, the AV amplifier 1 includes a control unit 2, a memory 3 such as a ROM and a RAM, a reproduction unit 4, an amplification unit 5, an operation unit 6, the display unit 7, and a communication unit 8. The control unit 2 controls the respective units of the AV amplifier 1, and is a microcomputer, a CPU or the like. The control unit 2 reads a content specification program stored in the ROM to the RAM and executes the same, thereby executing the content specification processing described later.

The reproduction unit 4 reproduces a tune file received in a streaming form from the server 10. The reproduction is decoding processing, D/A conversion processing and the like. The amplification unit 5 executes volume control processing and the amplification processing to an audio signal of the tune file reproduced by the reproduction unit 4 and supplies the audio signal to a speaker externally connected, which is not shown.

The operation unit 6 receives user operation, and is operation buttons provided in a front panel of the AV amplifier 1, a remote controller and the like. In the operation unit 6, cursor (up/down) keys, a menu key, an enter key, a return key and the like are provided.

The display unit 7 displays tune list screens as shown in FIGS. 2, 3, and is an LCD, an FL tube and the like. The display unit 7 may also perform OSD (On-Screen Display) of these screens on a display apparatus such as a TV receiver externally connected.

The communication unit 8 communicates with the server 10 via internet, and transmits a request for the tune list or the tune file to the sever 10 and receives the tune list and the tune file from the server 10.

When the tune list in FIG. 2 or FIG. 3 is displayed, and in a state where one tune is selected by the user operation (that is, the cursor is positioned to the tune), or in a state where the selected tune is being reproduced by the reproduction unit 4, an instruction to perform preset registration of the selected tune is inputted by the user operation, the control unit 2 performs the preset registration of the selected tune.

Particularly, the control unit 2 manages, in the memory 3, identification information of the selected tune, and identification information of one or a plurality of folders selected until the selected tune is reached from the root folder (or from the folder in the middle, which is true in the subsequent description). While the identification information is a title in the present example, it may be a number given to a hierarchical position of the folder or the tune, or the like. When one preset is selected from a preset list not shown by the user operation and a preset reproduction instruction is inputted, the control unit 2 automatically selects the folder or the tune from the tune list, using the title(s) of the one or the plurality of folders, and the title of the tune, which are managed in the memory 3 in association with the selected preset, and automatically specifies the tune to be reproduced from the tune list.

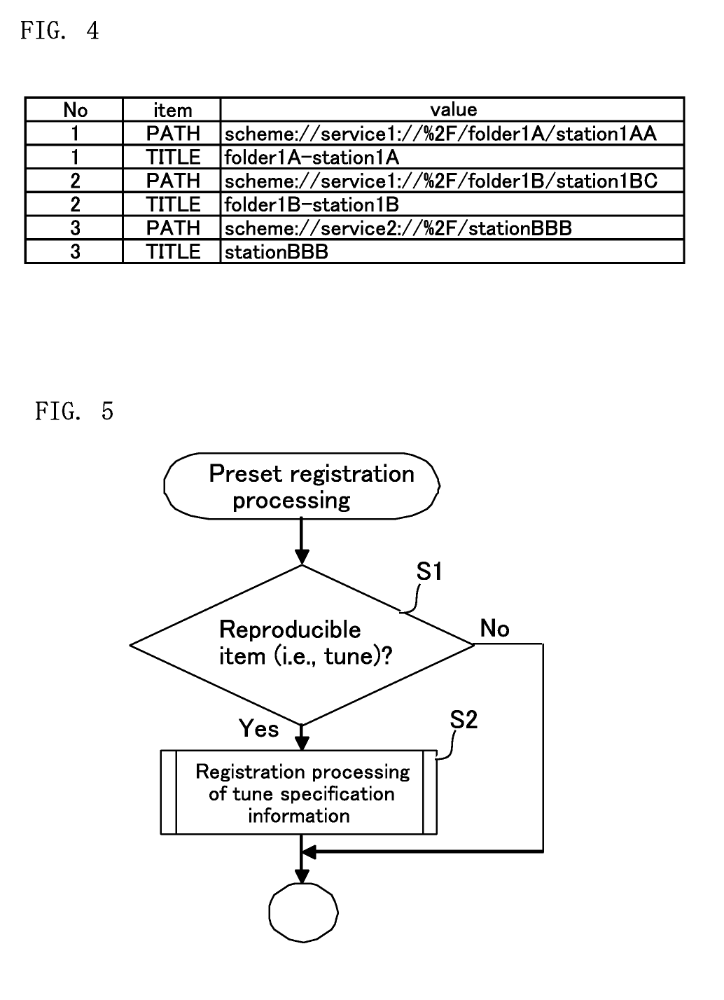

FIG. 4 is a diagram showing a tune specification table. The tune specification table is a table for managing the title of the selected tune, and the title(s) of the folder(s) selected until the selected tune is reached from the root folder. That is, the tune specification table is a table for preset registration. Particularly, a PATH and a TITLE are registered in association with NO., which is a preset number. The TITLE is a preset name displayed in the preset list, and can be arbitrarily given by the user operation.

The PATH is position information of the selected tune in the server 10, indicating the title of the selected tune, and the title(s) of the folder(s) selected until the selected tune is reached from the root folder. That is, a hierarchy of the tune list traced by the user operation until the tune is selected is indicated. In the present example, the PATH is configured, using a format of a general URL. When the PATH of the preset of No. 1 is described as one example, “scheme” at the head is a scheme name, indicating information used in the preset registration in the present example. “service1” is a service name, indicating a service name of an internet radio (a name of an internet radio station). “%2F” results from encoding “/”, indicating that a character string described immediately thereafter (here, “folder1A”) is a character string in the root folder. “folder1A” is a title of the folder. “station1AA” is a title of the tune. From the foregoing, the preset of NO. 1 indicates that the AV amplifier 1 is connected to “service1” server 10, that “folder1A” is selected from the root folder (or a folder in “service1”), and that “station1AA” is selected from “folder1A”.

Accordingly, when an instruction to reproduce the preset of NO. 1 is inputted by the user operation, the control unit 2 makes connection to the “service1” server 10, selects “folder1A” from the root folder (or the folder in “service1”), and selects “station1AA” from “folder1A”, thereby acquiring the preset tune from the server 10 and reproducing the same.

Next, the operation of the present embodiment is described. When one tune or folder is selected by the user operation from the tune list in FIG. 2 or FIG. 3, and an instruction to perform the preset registration is inputted, as shown in FIG. 5, the control unit 2 determines whether or not the item selected from the tune list is reproducible (i.e., not a folder but a tune) (S1). If the tune is selected (YES in S1), the control unit 2 executes registration processing of tune specification information (PATH, TITLE) (S2).

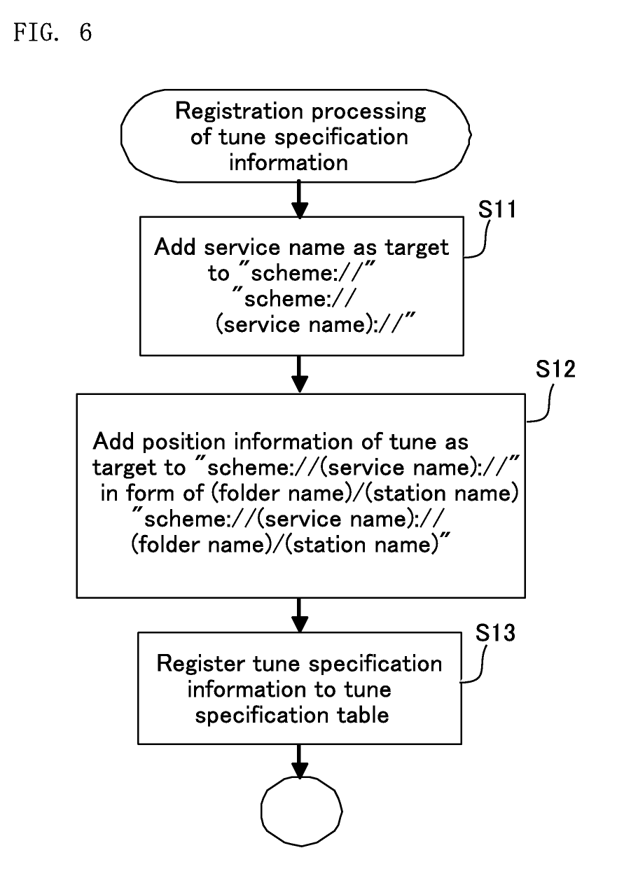

The registration processing of the tune specification information is shown in FIG. 6. The control unit 2 adds the service name (the name of the internet radio server) as a target after “scheme //” to obtain “scheme://(service name)://” (S11). Subsequently, the control unit 2 adds the position information of the selected tune in a form of (folder name)/(station name) after “scheme://(service name)://” to obtain “scheme://(service name):// (folder name)/(station name)” (S12). The control unit 2 registers the generated PATH in association with the preset number in the tune specification table in FIG. 4 (S13). At this time, the title of the preset is inputted by the user operation and registered in the TITLE.

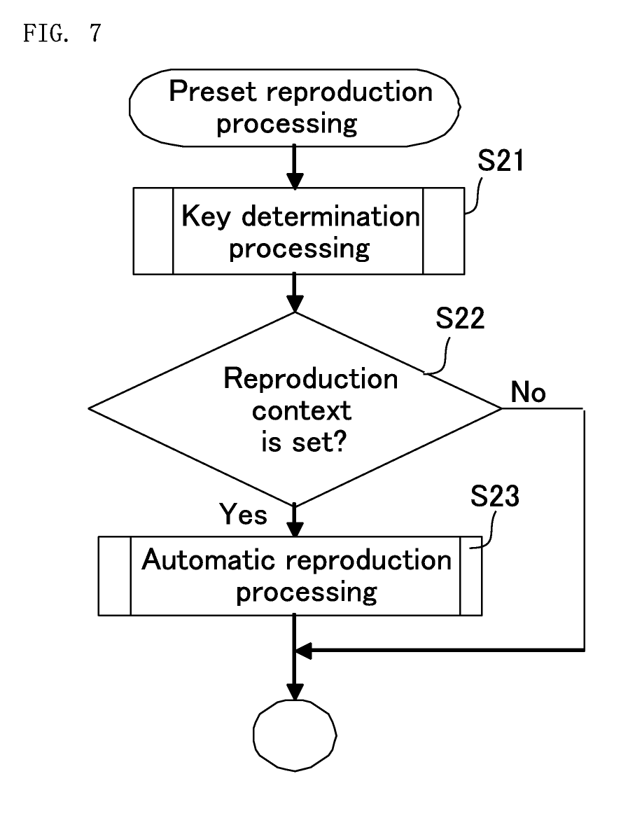

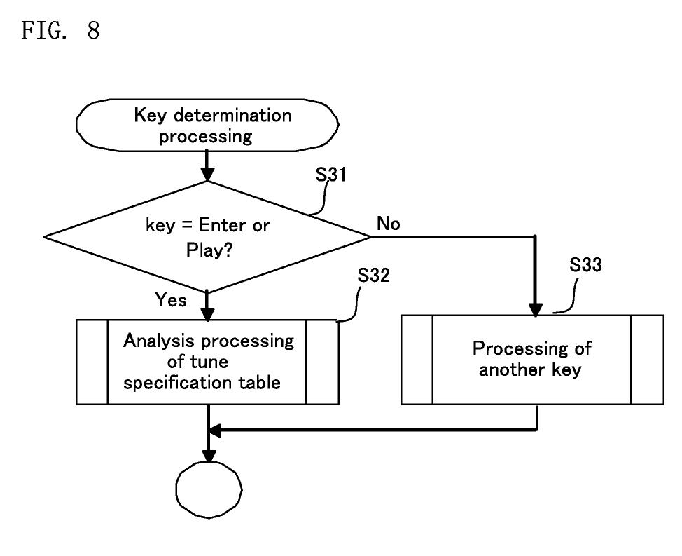

Next, a case is described, where the preset list, which is a list of the titles of the preset, is displayed, one of the titles of the preset is selected by the user operation, and the preset reproduction instruction is inputted. As shown in FIG. 7, the control unit 2 executes key determination processing (S21). Details of the key determination processing are shown in FIG. 8. The control unit 2 determines whether or not the key operated by a user is Enter or Play (S31). If the key is neither Enter nor Play (NO in S31), processing corresponding to the key is executed (S33). If the key is Enter or Play (YES in S31), the control unit 2 executes analysis processing of the tune specification table (S32).

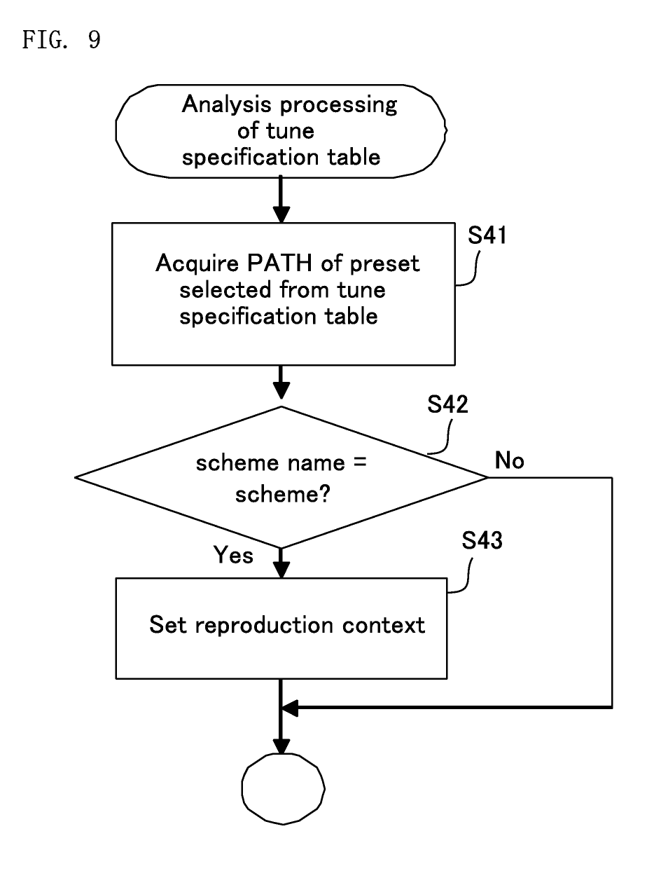

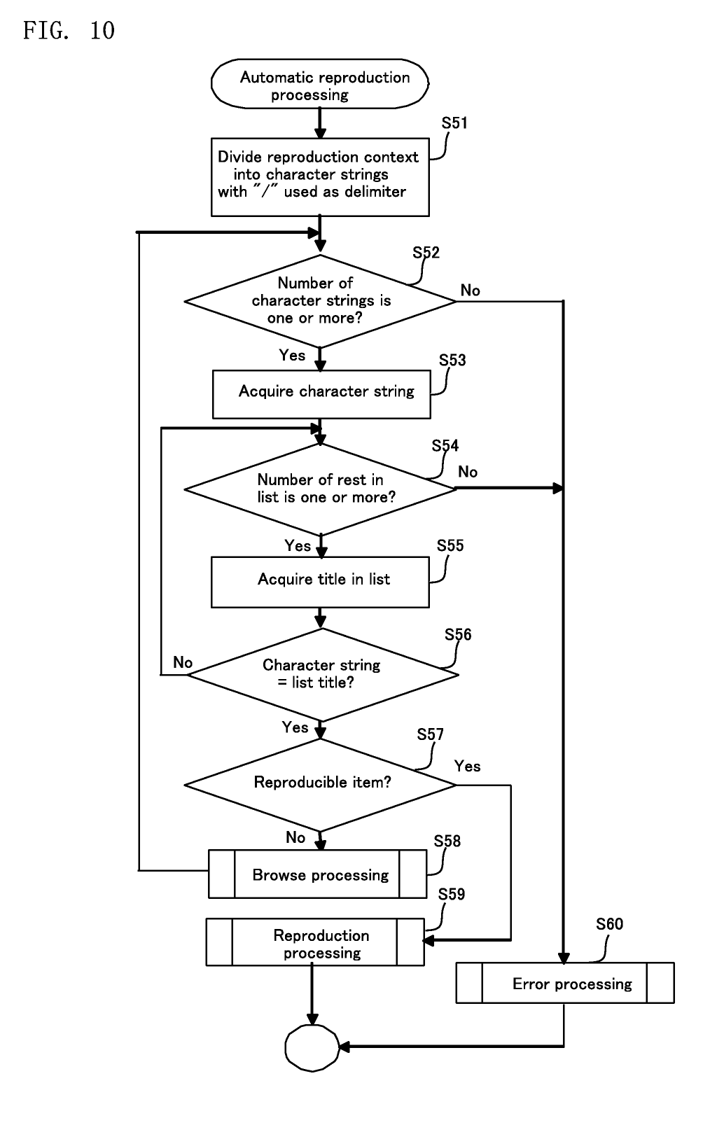

Details of S32 are shown in FIG. 9. The control unit 2 acquires the PATH corresponding to the title of the selected preset from the tune specification table (S41). For example, if the preset whose title is folder1A-station1AA is selected, “scheme://service1:/%2F/folder1A/station1AA” is acquired. The control unit 2 determines whether or not the scheme name is “scheme” in the acquired PATH (S42). If the scheme name is not “scheme” (NO in S42), the control unit 2 ends the processing, and if the scheme name is “scheme” (YES in S42), the control unit 2 sets a reproduction context in the memory 3. The reproduction context is information obtained by extracting a portion specifying the position of the tune from the PATH, and is obtained by extracting a portion after “%2F”. For example, if the PATH is “scheme://service1:/%2F/folder1A/station1AA”, the reproduction context is “folder1A/station1AA”.

Referring back to FIG. 7, the control unit 2 determines whether or not the reproduction context is set (S22). If the reproduction context is not set (S22), the control unit 2 ends the processing, and if the reproduction context is set (YES in S22), the control unit 2 executes automatic reproduction processing (S23).

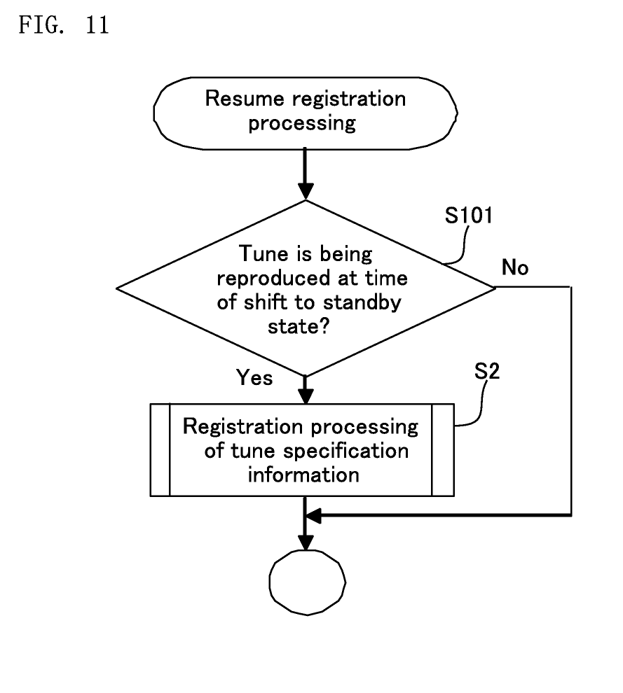

Details of the automatic reproduction processing are shown in FIG. 10. The control unit 2 divides the reproduction context into a plurality of strings with “/” used as a delimiter (S51). For example, when the reproduction context is “folder1A/station1AA”, the reproduction context is divided into the two character strings of “folder1A” and “station1AA”. The control unit 2 determines whether or not any character string that has not yet been acquired in S53 exists among the divided character strings (S52). If it does not exist (NO in S52), the control unit 2 executes error processing (S60) to end the processing.

If it exists (YES in S52), the control unit 2 selects one of the character strings in order from the beginning (S53). In the above-described example, “folder1A” is first selected. The control unit 2 connects to the server 10 specified by the service name of the PATH to acquire the tune list from the server 10. For example, if the PATH is “scheme://service1:/%2F/folder1A/station1AA”, the tune list shown in FIG. 2 is acquired from the server 10 as “service1”.

The control unit 2 determines whether or not the title that has not yet been acquired in S55 exists among the titles of the folders or the tunes included in the tune list in FIG. 2 (S54). Here, since it exists (YES in S54), the control unit 2 acquires one of the titles of the folders or the tunes included in the tune list in FIG. 2 in order from the beginning (S55). The control unit 2 determines whether or not the character string acquired in S53 matches the title acquired in S55 (S56). If the character string does not match the title (NO in S56), the processing returns to S54 to acquire the next title in the tune list in FIG. 2 (S55). In the present example, since “folder1A” acquired in S53 matches the title first acquired in the tune list in FIG. 2 (YES in S56), the control unit 2 determines whether or not the title that has matched in S56 is a reproducible item (i.e., not a folder but a tune) (S57).

Since “folder1A” is not a reproducible item (i.e., it is a folder) (NO in S57), the control unit 2 requires the tune list of “folder1A” (refer to FIG. 3) to the server 10, acquires the same (S58), and returns to S52. Next, since the character string that has not yet been acquired in S53 exists among the divided character strings (YES in S52), the control unit 2 acquires “station1AA”, which is the next character string (S53).

The control unit 2 acquires one of the titles in the tune list in FIG. 3 in order from the beginning (S54, S55), and determines whether or not the title matches the character string acquired in S53 (S56). Since “station1AA” matches the first title in the tune list in FIG. 3 (YES in S56), and is the reproducible item (not a folder but a tune) (YES in S57), the control unit 2 requests “station1AA” in the tune list in FIG. 3 to the server, and acquires the same to cause the reproduction unit 4 to reproduce the same (S59).

As described above, according to the present embodiment, in place of storing the URL of the selected tune, the title of the selected tune, and the title(s) of the folder(s) selected until the selected tune is reached are managed as the PATH in the tune specification table. When the preset is selected and the reproduction instruction is inputted, the PATH managed in association with the selected preset is used to automatically select the folder and the tune from the tune list, which enables the preset tune to be automatically specified from the tune list.

Next, another preferred embodiment of the present invention is described. In the present example, in the case where when the selected tune is being reproduced, the AV amplifier 1 shifts from a power-on state to a standby state in response to the user operation, the control unit 2 manages, in the memory 3, the identification information (title) of the tune being reproduced, and the identification information (title(s)) of the one or the plurality of folders selected until the selected tune is reached. In the case where the AV amplifier 1 shifts from the standby state to the power-on state by the user operation, the control unit 2 automatically specifies the tune to be subjected to resume reproduction, using the title(s) of the one or the plurality of folders, and the title of the tune, which are managed in the memory 3. The standby state is a state where power supply voltage is supplied only to the control unit 2 and peripheral circuits thereof without supplying the power supply voltage to the other units.

In the present example, only one PATH is managed in the tune specification table in FIG. 4. The operation in the present example is schematically the same as that in the preset registration. That is, when the AV amplifier 1 shifts from the power-on state to the standby state, whether or not the tune is currently being reproduced in S101 in FIG. 11 is determined, and if the tune is being reproduced (YES in S101), the processing goes to S2 (FIG. 6) to register the PATH in the tune specification table.

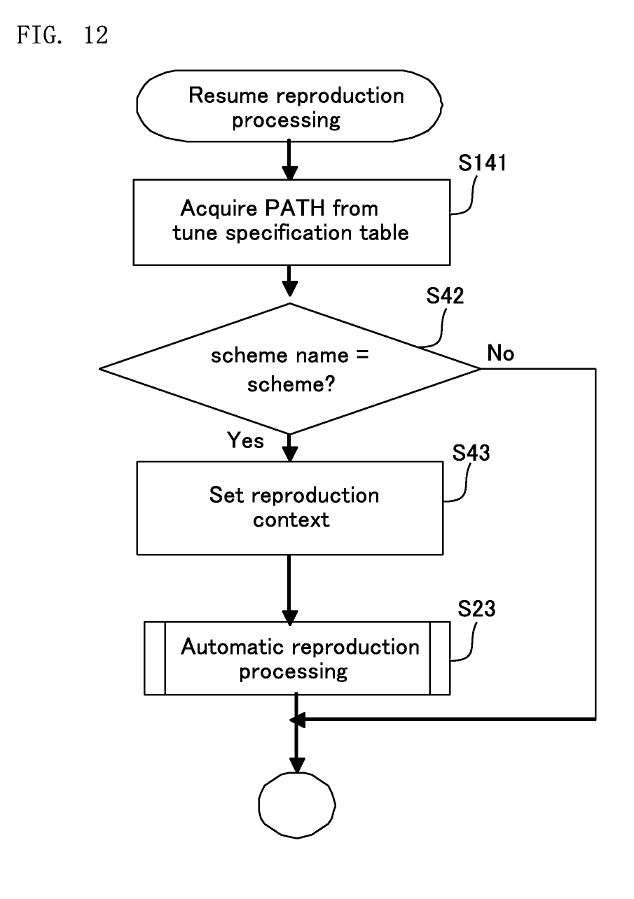

When the AV amplifier 1 shifts from the standby state to the power-on state, the only PATH managed in the tune specification table is acquired in FIG. 12 (S141), and the reproduction context is set (S42, S43), and then the automatic reproduction processing (resume reproduction) in FIG. 10 is executed.

According to the foregoing processing, the title of the tune, and the title(s) of the folder(s) selected until the selected tune is reached are managed as the PATH in the tune specification table in place of storing the URL of the tune being reproduced when the AV amplifier 1 shifts to the standby state. When the AV amplifier 1 shifts to the power-on state, using the PATH managed in the tune specification table, the folder(s) and the tune are automatically selected from the tune list, by which the tune to be subjected to the resume reproduction can be automatically specified from the tune list.

While as described above, the preferred embodiments of the present invention have been described, the present invention is not limited to these embodiments. The present invention is not limited to the case where the tune is acquired from the server, but can be applied to a case where in a PC, an HDD recorder, a portable audio player and the like, a tune recorded on a storage medium thereof is specified. The PATH is not limited to the URL form, but the identification information of the one or the plurality of folders and the identification information of the tune may be managed in a table form. Both of the above-described preset registration/reproduction processing and the resume registration/reproduction processing may be executed. The present invention may be provided as a form of a computer program to cause a computer to implement the above-described content specifying apparatus, or a recording medium that records the computer program.

What is claimed is:

1. A content specifying apparatus comprising:
a list acquiring unit that acquires a content list including identification information of one or a plurality of folders, and/or identification information of one or a plurality of contents;
a selection unit that selects a content from the content list in response to user operation;
a management unit that manages the identification information of the selected content and the identification information of one or a plurality of folders selected until the selected content is reached; and
a specification unit that specifies the content from the content list, using the identification information of the one or the plurality of folders and the identification information of the content managed by the management unit.

2. The content specifying apparatus according to claim 1, wherein the specification unit selects, from the content list, the folder specified by the identification information of the folder managed by the management unit, and selects, from the content list, the content specified by the identification information of the content managed by the management unit.

3. The content specifying apparatus according to claim 1, further comprising a reproduction unit that reproduces the content specified by the specification unit,
wherein when an instruction to subject the selected content to preset registration is inputted by user operation, the management unit manages the identification information of the selected content, and the identification information of the one or the plurality of folders selected until the selected content is reached, and
when an instruction to perform preset reproduction is inputted by user operation, the specification unit specifies the content from the content list, and the reproduction unit reproduces the content specified by the specification unit.

4. The content specifying apparatus according to claim 1, further comprising a reproduction unit that reproduces the content selected by the selection unit or the content specified by the specification unit,
wherein when the content specifying apparatus shifts from a power-on state to a standby state, the management unit manages the identification information of the content being reproduced by the reproduction unit and the identification information of the one or the plurality of folders selected until the content being reproduced by the reproduction unit is reached, and
when the content specifying apparatus shifts from the standby state to the power-on state, the specification unit specifies the content from the content list, and the reproduction unit reproduces the content specified by the specification unit.

5. A content specifying method including:
a list acquiring step that acquires a content list including identification information of one or a plurality of folders, and/or identification information of one or a plurality of contents;
a selection step that selects a content from the content list in response to user operation;
a management step that manages the identification information of the selected content and the identification information of one or a plurality of folders selected until the selected content is reached; and
a specification step that specifies the content from the content list, using the identification information of the one or the plurality of folders and the identification information of the content managed by the management step.

6. The content specifying method according to claim 5, wherein the specification step selects, from the content list, the folder specified by the identification information of the folder managed by the management step, and selects, from the content list, the content specified by the identification information of the content managed by the management step.

7. The content specifying method according to claim 5, further including a reproduction step that reproduces the content specified by the specification step,
wherein when an instruction to subject the selected content to preset registration is inputted by user operation, the management step manages the identification information of the selected content, and the identification information of the one or the plurality of folders selected until the selected content is reached, and
when an instruction to perform preset reproduction is inputted by user operation, the specification step specifies the content from the content list, and the reproduction step reproduces the content specified by the specification step.

8. The content specifying method according to claim 5, further including a reproduction step that reproduces the content selected by the selection step or the content specified by the specification step,
wherein when the content specifying apparatus shifts from a power-on state to a standby state, the management step manages the identification information of the content being reproduced by the reproduction step and the identification information of the one or the plurality of folders selected until the content being reproduced by the reproduction step is reached, and
when the content specifying apparatus shifts from the standby state to the power-on state, the specification step specifies the content from the content list, and the reproduction step reproduces the content specified by the specification step.

9. A computer program stored on a computer-readable medium causing a computer in a content specifying apparatus to perform:
a list acquiring step that acquires a content list including identification information of one or a plurality of folders, and/or identification information of one or a plurality of contents;
a selection step that selects a content from the content list in response to user operation;
a management step that manages the identification information of the selected content and the identification information of one or a plurality of folders selected until the selected content is reached; and
a specification step that specifies the content from the content list, using the identification information of the one or the plurality of folders and the identification information of the content managed by the management step.
